(19) United States
(12) Patent Application Publication
(10) Pub. No.: US 2025/0229637 A1
(43) Pub. Date: Jul. 17, 2025

(54) Method for Replacing a Drive Unit of a Vehicle

(71) Applicant: Robert Bosch GmbH, Stuttgart (DE)

(72) Inventors: Sebastian Schmidt, Reutlingen (DE); Daniel Kuhn, Dettingen An Der Erms (DE); Stefan Kuttler, Dusslingen (DE); Patrick Millen, Metzingen (DE)

(21) Appl. No.: 18/699,124

(22) PCT Filed: Sep. 15, 2022
(86) PCT No.: PCT/EP2022/075675

§ 371 Date: Apr. 5, 2024

(30) Foreign Application Priority Data
Oct. 7, 2021 (DE) 10 2021 211 318.4

(51) Int. Cl. B60L 3/00; B60L 50/20; B62J 50/22; B62M 6/45

(52) U.S. Cl. CPC B60L 3/0061; B60L 50/20; B62J 50/22; B62M 6/45; B60L 2200/12; B60L 2200/46

(57) ABSTRACT

A method for replacing a drive unit of a vehicle, in particular of an electric bicycle, includes (i) capturing identification features of a first drive unit of a vehicle by way of a first service device, wherein the identification features uniquely represent the first drive unit, (ii) transmitting the identification features from the first service device to a second service device, (iii) generating configuration data by way of the second service device on the basis of the identification characteristics, (iv) transmitting the configuration data from the second service device to the first service device, (v) providing a second drive unit at the first service device, and (vi) configuring the second drive unit by way of the first service device using the configuration data.

### THE PRIOR ART

The present invention relates to a method for replacing a drive unit of a vehicle, in particular an electric bicycle.

Drive units of electric bicycles often cannot be repaired or replaced by the user or a conventional workshop in the event of defects. This is, e.g., done for legal reasons and to prevent manipulation and abuse. Instead, the defective drive unit is usually sent to the manufacturer or to a special certified workshop, e.g. by mail. However, performing such a replacement of a drive unit of an electric bicycle to restore functionality of the electric bicycle is usually time consuming and cost-intensive.

### DISCLOSURE OF THE INVENTION

In contrast, the method according to the invention having the features of claim 1 is characterized in that a drive unit can be replaced in a particularly simple and cost-efficient manner in order to restore a functionality of the vehicle in a time-efficient manner, with little effort, and at a low cost. According to the present invention, this is achieved by a method for replacing a drive unit of a vehicle. The vehicle is preferably an electric bicycle. The drive unit is in this case preferably provided to assist the pedaling force of an electric bicycle rider generated by muscle power. The method comprises the steps of:
capturing identification features of a first drive unit of a vehicle by a first service device, whereby the identification features uniquely represent the first drive unit,
transmitting the identification features from the first service device to a second service device,
generating configuration data by means of the second service device on the basis of the identification characteristics,
transmitting the configuration data from the second service device to the first service device,
providing a second drive unit at the first service device, and
configuring the second drive unit by means of the first service device using the configuration data.

In other words, regarding the method, the physical replacement of a (e.g., partially defective) first drive unit of a vehicle with a second drive unit can be performed on or by the first service device. The configuration of the second drive unit, preferably to enable use on the vehicle, is in this case also performed by providing corresponding configuration data to the first service device. However, these configuration data are not generated by the first service device itself, but by the second service device which can, e.g., be located at a different geographic location than the first service device. The generation of the configuration data by the second service device is based on the identification features of the first drive unit, i.e., only when the second service device has received and preferably checked the identification features.

In particular, the generation of the configuration data is in this case performed such that the second service device provides the same properties and/or functions as the first drive unit after configuration. In other words, a “clone” of the first drive unit is therefore provided in the method.

The first service device can, e.g., be a service device, e.g. a bicycle dealer or a workshop, that is not authorized to make certain changes to drive units of vehicles, such as generating or changing configuration data. A high degree of security against manipulation or misuse can be enabled as a result of the configuration data only being generated by a further second service device, which is preferably authorized to make the changes specified hereinabove.

The transmission of the identification features and/or the configuration data can preferably be performed via any desired method of data transfer. As a result, by means of the method, it is particularly simple, time-efficient, and cost-efficient to replace the drive unit of the vehicle in order to restore the full functionality of the vehicle.

The dependent claims relate to preferred embodiments of the invention.

Preferably, the method further comprises the steps of:
disassembling the first drive unit from the vehicle, and
assembling the second drive unit on the vehicle. The first drive unit is preferably disassembled from the vehicle at the earliest after the identification features of the first drive unit have been captured. The second drive unit is preferably assembled immediately after providing the second drive unit to the first service device.

Particularly preferably, the second drive unit can only be configured after the second drive unit has been assembled on the vehicle. In other words, as long as the second drive unit is not yet assembled on the vehicle, the configuration is prevented. As a result, further security can be provided against manipulation or the like.

The configuration data preferably define one or more of the following properties and/or functions:
control of a motor torque that can be provided by the second drive unit as a function of one or more of the following parameters: driver force or driver torque, assist mode, driver profile;
motor torque limiting when exceeding a driving speed of 25 km/h or 45 km/h,
a wheel circumference of a rear wheel of the vehicle,
a gear ratio of a vehicle gearshift,
maximum assist power of the second drive unit.
   The term “assist mode” is in this case considered to be an operating mode of the drive unit, which can be set by the driver of the vehicle, in which, e.g., different levels of torque assistance can be selected. For example, a first operating mode featuring low assistance, in which the drive unit provides a maximum of 20% of a maximum possible motor torque, or a second operating mode featuring high assistance, in which the drive unit provides up to 100% of the maximum possible motor torque can be provided. Driver profiles are, e.g., operating modes of the drive unit optimized for a specific driver of the vehicle according to individual requirements.

The configuration data are preferably individualized when the second service device generates the configuration data. In particular, additional replacement identification features are in this case generated that uniquely represent the second drive unit. For example, the replacement features are transmitted to the second drive unit along with or as part of the configuration data. As a result, it possible that, e.g., if the second drive unit subsequently needs to be replaced, e.g. due to a defect, it can also be replaced using the described method.

Preferably, the method further comprises the step of: determining a functionality of the first drive unit by means of the first service device. In particular, when determining the functionality, it is checked whether the first drive unit is fully or partially defective and/or whether certain functions of the first drive unit are functional.

Generation of the configuration data is preferably prevented if the first drive unit is functional without restriction, in particular by means of the second service device. Preferably, alternatively, or additionally, generation of the configuration data is only possible given at least partially restricted functionality of the first drive unit. In other words, cloning of the first drive unit is only allowed given a corresponding need due to limited functionality which can, e.g., occur due to a defect.

Further preferably, the method further comprises the step of: determining an allowability of a replacement of the first drive unit based on the identification features. Generation of the configuration data can in this case only be performed given affirmative determination of the allowability of the configuration. Allowability can in this case be defined by a variety of features, and/or properties of the first drive unit, and/or by further conditions. As a result of the second service device first checking the allowability of the replacement based on the identification features, a particularly secure method can be provided which is also particularly efficient because, e.g., given a lack of allowability, the further unnecessary method steps can be prevented.

Preferably, the replacement of the first drive unit is determined to be allowable if the first drive unit and the second drive unit are structurally identical. In particular, additional properties of the second drive unit are first checked by the second service device. As a result, unsuitable drive units are, e.g., prevented from being used as spare parts on the vehicle, while making the method easy to perform.

Preferably, the method further comprises the step of: determining an allowability of the configuration of the second drive unit. This is preferably performed by checking a compliant configuration of the second drive unit. The configuration of the second drive unit is in this case only possible given affirmative determination of the allowability of the configuration, and is in particular actively prevented by the second service device given a lack of allowability. In particular, a suitability of the second drive unit for use in the vehicle, preferably confirmed by recognized approval, e.g. with regard to operation of the vehicle in road traffic, is considered to be a compliant configuration.

Particularly preferably, the method further comprises the step of: deactivating the first drive unit such that torque generation by the first drive unit is prevented after deactivation. In other words, the first drive unit is rendered harmless for appropriate use. For example, the deactivation can be performed by changing the configuration data of the first drive unit. Preferably, a diagnostic capability of the first drive unit is excluded from deactivation. In other words, even after deactivation, communication of the first drive unit with a service device is generally possible.

The deactivation is preferably performed prior to generation of the configuration data. As a result, the simultaneous presence of two at least partially functional (i.e., potentially torque-generating) drive units is reliably prevented.

Further preferably, the second drive unit is deconfigured when provided to the first service device, and in particular before the step of configuration. In other words, the second drive unit is, e.g., in this case only available as a mechanical component which does not yet possess any software functions. In particular, the unconfigured state of the second drive unit means that it is not yet suitable for use, in particular not for generating torque.

Preferably, the first service device and the first drive unit, as well as the second drive unit and the vehicle, are located in a common location. The second service device is in this case located in a different location which is remote from the first service device. The data and information exchange between the two service devices can in this case be performed by means of a communication link. The method does not in this case require the replacement or transport of physical objects between the various locations.

### BRIEF DESCRIPTION OF THE DRAWINGS

The invention is described in the following with reference to an exemplary embodiment in conjunction with the drawings. In the drawings, functionally identical components are in each case identified by identical reference characters. Shown are:

FIG. 1 a simplified schematic view of an arrangement for performing a method according to a preferred exemplary embodiment of the invention, and

FIG. 2 a simplified schematic view of the method steps of the method of FIG. 1.

### PREFERRED EMBODIMENTS OF THE INVENTION

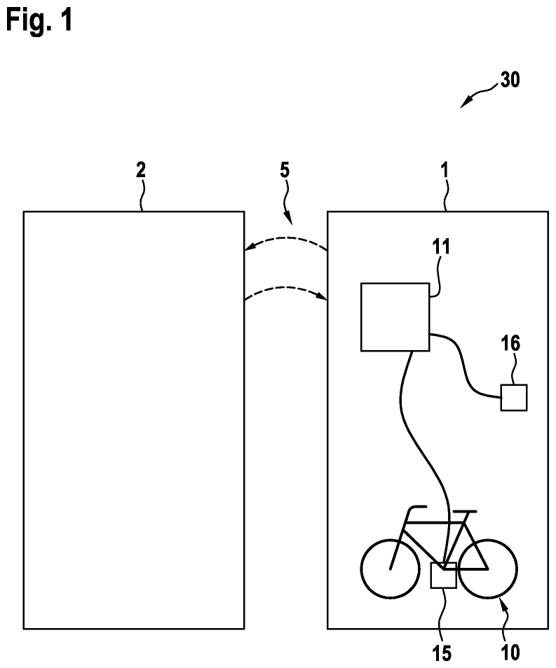

FIG. 1 shows a simplified schematic view of an assembly 30 by means of which a method 50 for replacing a drive unit of a vehicle 10 according to a preferred embodiment of the invention is performed.

The vehicle 10 is an electric bicycle that can be operated using muscle power and/or motor power. The vehicle 10 in this case comprises a first driving unit 15, which comprises an electric motor that can be supplied with electrical energy by way of an electrical energy storage means. The first drive unit 15 is configured to generate a motor torque to assist a driver torque applied by the muscle power of the rider.

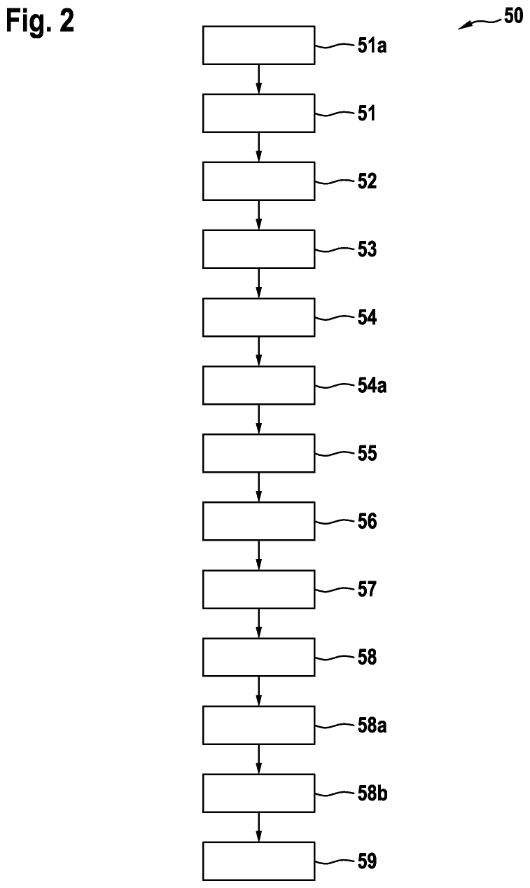

Given defects or failures of the first drive unit 15, it may be necessary to replace them with a functional second drive unit 16. For this purpose, the method 50 is performed according to the preferred exemplary embodiment as described hereinafter. The successive steps of method 50 are in this case shown schematically in simplified form in FIG. 2.

The vehicle 10 is in this case located at a first service device 1 which can, e.g., be a bicycle dealer, a cycling workshop, or the like. The first service device 1 can communicate with a second service device 2 via a communication link 5, i.e. replace data and information. The second service device 2 is, e.g., a manufacturer of the vehicle 10 and/or the drive unit 15.

The service device 1 preferably comprises a service unit 11, which can, e.g., be a computer or the like.

In a first step 51a, the first drive unit 15 is connected to the service unit 11. Identification features of the first drive unit 15 are then captured 51, which uniquely represent the first drive unit 15.

Preferably, the second drive unit 16 is also connected to the service unit 11. In this case, the second drive unit 16 is in particular identical in design to the first drive unit 15 and is provided in an unconfigured state at the first service device 1.

In the next step, a determination 52 of a functionality of the first drive unit 15 is performed by means of the first service device 1. If, for example, an unrestricted functionality of the first drive unit 15 is determined, then further performance of the method 50 is prevented.

If an at least partially restricted functionality of the first drive unit 15 and therefor the need for a replacement has been determined, then the identification features are subsequently transmitted 53 from the first service device 1 to the second service device 2.

The second service device 2 then determines in step 54 an allowability of the replacement of the first drive unit 15. The determination 54 of the allowability can in this case be based on a plurality of criteria. For example, one of these criteria can be that the first drive unit 15 and the second drive unit 16, which is to replace the first drive unit 15, must be structurally identical.

Furthermore, a determination 54a of an allowability of a subsequent configuration 59 of the second drive unit 16 is made. In this case, a homologation of the second drive unit 16 can, e.g., be checked with regard to the vehicle 10.

Given affirmative determination of the allowability of the configuration 59, the first drive unit 15 is then deactivated 55. The deactivation 55 is in this case performed such that, e.g., by adjusting a corresponding configuration of the first drive unit 15, the first drive unit 15 is prevented from still being able to generate a torque after deactivation 55.

Only when the first drive unit 15 has been successfully deactivated does the generation 56 of configuration data occur by the second service device 2. For example, the configuration data generated by the second service device 2 can correspond to the configuration data of the first drive unit 15 in its original state.

Transmission 57 of the newly generated configuration data then occurs from the second service device 2 to the first service device 1.

The provision 58 of the second drive unit 16 then occurs, which in the preferred embodiment shown can be considered as the physical replacement of the first drive unit 15 by the second drive unit 16. In this case, first a disassembly 58a of the first drive unit 15 from the vehicle 10, and then an assembly 58b of the second drive unit 16 on the vehicle 10 occurs.

Finally, the configuration 59 of the second drive unit 16 is performed by means of the configuration data generated and transmitted by the second service device 2.

The method 50 therefore offers the advantage that replacement of the first drive unit 15 from the perspective of the user of the vehicle 10 is particularly simple, convenient and time-efficient. In addition, a high level of security against manipulation or fraud attempts is thereby provided. For example, if the first service device 1 does not have the necessary rights to independently configure drive units 15, 16, the method 50 can still provide a simple and secure replacement, in which case physical transport of one or both drive units 15, 16 between the first service device 1 and the authorized second service device 2 can, e.g., be omitted. It is in this case only necessary to have an unconfigured second drive unit 16 available as a spare part at the first service device 1.

1. A method for replacing a drive unit of a vehicle, comprising:
capturing identification features of a first drive unit of a vehicle by way of a first service device, wherein the identification features uniquely represent the first drive unit,
transmitting the identification features from the first service device to a second service device,
generating configuration data by way of the second service device on the basis of the identification features,
transmitting the configuration data from the second service device to the first service device,
providing a second drive unit at the first service device, and
configuring the second drive unit by way of the first service device using the configuration data.

2. The method according to claim 1, further comprising:
disassembling the first drive unit from the vehicle, and
assembling the second drive unit on the vehicle.

3. The method according to claim 2, wherein configuration of the second drive unit is performed only after assembling the second drive unit on the vehicle.

4. The method according to claim 1, wherein the configuration data define one or more of the following properties of the second drive unit:
rider force-dependent control of a motor torque that is provided by the second drive unit,
assistance mode-dependent control of a motor torque that is provided by the second drive unit,
motor torque limiting when exceeding a driving speed of 25 km/h or 45 km/h,
driver profile-dependent control of a motor torque that is provided by the second drive unit,
a wheel circumference of a rear wheel of the vehicle,
a gear ratio of a vehicle gearshift, and
maximum assist power of the second drive unit.

5. The method according to claim 1, wherein, when generating the configuration data, the configuration data are individualized by the second service device by generating additional replacement identification features uniquely representing the second drive unit.

6. The method according to claim 1, further comprising:
determining a functionality of the first drive unit by way of the first service device.

7. The method according to claim 6, wherein:
generation of the configuration data is prevented given unrestricted functionality of the first drive unit.

8. The method according to claim 1, further comprising:
determining an allowability of a replacement of the first drive unit based on the identification features,
wherein generation of the configuration data is only performed given affirmative determination of the allowability of the replacement.

9. The method according to claim 8, wherein replacement of the first drive unit is determined to be allowable if the first drive unit and the second drive unit are structurally identical.

10. The method according to claim 1, further comprising:
determining an allowability of configuration of the second drive unit by checking a homologation of the second drive unit,
wherein configuration of the second drive unit is only performed given affirmative determination of the allowability of the configuration.

11. The method according to claim 1, further comprising:
deactivating the first drive unit such that, after deactivation, torque generation by the first drive unit is prevented.

12. The method according to claim 11, wherein the deactivation is performed prior to generation of the configuration data.

13. The method according to claim 1, wherein the second drive unit is unconfigured when provided.

14. The method according to claim 1, wherein:
the first service device, the first drive unit, the second drive unit, and the vehicle are located in a common location, and
the second service device is located in another location remote from the first service device.

15. The method according to claim 1, wherein the vehicle is an electric bicycle.
